(19) United States
(12) Patent Application Publication
(10) Pub. No.: US 2006/0000257 A1
(43) Pub. Date: Jan. 5, 2006

(54) System and method for proactive health and environmental management and assessment

(75) Inventors: Mansour Samadpour, Seattle, WA (US); Robert Miksch, Seattle, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Institute for Environmental Health, Lake Forest Park, WA (US)

(21) Appl. No.: 11/153,024

(22) Filed: Jun. 14, 2005

Related U.S. Application Data
(60) Provisional application No. 60/683,400, filed on May 19, 2005.
(60) Provisional application No. 60/579,446, filed on Jun. 14, 2004.

(51) Int. Cl. G01N 19/10; G01N 7/00

(52) U.S. Cl. 73/23.2; 73/29.01

(57) ABSTRACT

Particular aspects of the present invention provide novel systems and methods for method for epidemiological and environmental monitoring and assessment, and for active management of human health hazards associated with building environments. In particular aspects, the inventive system and methods are used as a human health and environmental health management tool for corporations (e.g., offices, factories), commercial buildings, condominiums, hotels, resorts, camps, military installations, schools, daycares, cruise ships, real estate developments, towns and cities, prisons, or any other institutional or community settings. In particular aspects, the inventive system and methods are used in a proactive manner to maintain the health of building occupants. Additional aspects provide systems and methods having substantial utility as an investigative tool to substantiate human health claims and correlate underlying environmental factors.

### CROSS-REFERENCE TO RELATED APPLICATIONS

The application claims the benefit of priority to U.S. Provisional Patent Application Ser. Nos. 60/579,446, filed Jun. 14, 2004 and entitled SYSTEM AND METHOD FOR PROACTIVE HEALTH AND ENVIRONMENTAL MANAGEMENT AND ASSESSMENT, and 60/683,400, filed May 19, 2005 of same title, both of which are incorporated by reference herein in their entirety.

### FIELD OF THE INVENTION

Particular aspects of the present invention relate generally to systems and methods for epidemiological and environmental monitoring and assessment, and for providing improved methods to correlate, monitor and analyze adverse health effect incidence rates in view of potential causative factors, and more specifically to novel integrated systems and methods for continuously collecting data regarding adverse health effects among groups (e.g., building occupants), and applying comparative and statistical methods to identify health related trends and correlations with, for example, environmental variables.

### BACKGROUND

The impact of environmental factors (e.g., buildings) on human health is of increasing interest and concern. Building-related health concerns relate to physical plant parameters such as indoor air quality, quality of indoor plumbing, improper use of asbestos and lead in building materials, radon in air, etc. However, while the condition of various aspects of typical institutional buildings and facilities may well impact worker health, such physical plant parameters are inherently complex and heterogeneous, and are thus difficult to monitor.

Environmental factors play a significant role in determining the quality of public health. School children, in particular, are more susceptible to experiencing adverse health effects from harmful environmental factors, because of their developing bodies and immunities, their size, and their behaviors. Moreover, school children spend most of their day at school, with much of it in institutional buildings.

The current art relating to monitoring building-related health concerns is premised on, and relies on epidemiological investigation; that is, monitoring and analyses occurs after clusters of illnesses appear, and subsequent environmental measurements my or may not be taken to attempt to identify problems and causes. Thus, prior art systems are reactive rather than proactive or predictive, because they are designed to only to respond to problems after they occur. Prior art systems thus have little if any utility for initial illness prevention.

Therefore, there is a pronounced need in the art for novel methods to monitor and integrate physical plant parameters to enable management of the health workers, tenants and wards. The is a need for systems that not only merely identify illnesses to guide subsequent reactive environmental intervention measures, but that can also provide continuous, real-time, or substantially real-time data (e.g., health data, environmental data, etc) collection with application of statistical process control to provide for proactive epidemiological conclusions and fro proactive and reactive interventions.

There is a pronounced need in the art to link human health data to environmental parameters (e.g., of a particular physical environment), to ascertain the impact of environmental parameters on an individual's (e.g., building occupant's) health, and to be able to proactively manage the environmental factors to minimize human health hazards.

There is a pronounced need in the art to develop a surveillance system that monitors the relationship between adverse health effects among, for example, school children and school environmental conditions to provide for both proactive and reactive measures.

There is a pronounced need in the art to provide baseline information on illness rates, and provide a means for the early detection of disease outbreaks or changes in environmental conditions that enable proactive intervention.

### SUMMARY OF THE INVENTION

Particular aspects of the present invention provide novel systems and methods for active (e.g., proactive) management of human health hazards associated with the corresponding and immediate physical environment. In particular embodiments, inventive systems and methods are used as a human health and environmental health management tools for various situations, including but not limited to corporations (e.g., offices, factories), commercial buildings, condominiums, hotels, resorts, camps, military installations, schools, daycares, cruise ships, real estate developments, towns and cities, prisons, or any other institutional or community settings. In particular aspects, embodiments of the inventive system and methods are used in a proactive manner to maintain the health of building occupants. In alternate aspects, embodiments of the inventive system and methods are used as an investigative tool to substantiate human health claims and their underlying environmental factors.

Additional aspects comprise use of a confidential human health active database that identifies each building inhabitant and chronologically documents their health symptoms (e.g., types and severity), and any respective medical diagnoses. In particular embodiments, preexisting conditions are noted in the database for each individual. Preferably, physical parameters are noted for each individual.

In further aspects, each symptom or group (combinations) of symptoms are routinely monitored and analyzed for occupants of each building to establish respective incident rates. In particular embodiments, the incident rates for occupants of various buildings are compared to each other to determine baseline incident rates, and significant rises over the baseline incident rates for any building. In certain embodiments, the buildings, depending, for example, on building structure and makeup of their occupants, are matched to each other to provide for case control studies. In particular embodiments, environmental exposure data are analyzed to establish relative risk, and odds ratios.

In further aspects, a number of environmental parameters, including but not limited to temperature, relative humidity, CO₂ concentration, CO concentration, particulate matter, allergens, fumes, toxins, airborne microbes, molds, chemicals and microbes in drinking water, etc., are monitored and measured using remote sensing devices or other appropriate measurement/sampling/analysis techniques. In particular embodiments, building-related environmental conditions are linked to particular symptoms. In preferred embodiments, the data is collected frequently (e.g., continuously, hourly, daily, weekly, monthly, etc) and analyzed to ascertain emergence clusters of human illnesses and symptoms, and the environmental data is analyzed to predict, confirm or dismiss involvement of environmental and/or building factors on the emergence of human health effects. Preferably, the environmental conditions are monitored to maintain a healthy environment.

In particularly preferred embodiments, the data collection system and the database are continuously ‘mined’ for various purposes including, but not limited to: (a) identifying and/or predicting the emergence of health-effect clusters, their relationships to buildings and individual's immediate environment; (b) determining the location specific clusters; (c) comparing clusters/cases from each location to the incident rate (IR) baselines (e.g., cumulative and recent baselines of incident rates), and to baseline and IRs for each location; (d) testing the significance between the incident rates from comparable locations (case-controls); (e) tracking relations of clusters of health effects; (f) dividing emerging clusters into acute or chronic clusters; (g) monitoring and tracking an individual's environmental relationships and locations; (h) monitoring chronic symptomatic conditions, and determining relationships of emerging clusters to health conditions of a respective larger community; (i) determining the relationship of clusters and their locations to site-specific environmental measurements; (j) and determining the potential role of the building and/or environmental conditions on the emergence of the health effects.

Particular aspects provide a method for epidemiological and environmental monitoring and assessment, comprising: configuring, in one or a plurality of electronic databases stored in a storage device of a computer, a set of health-related occurrence data including respective occurrence dates, and a respective set of building environment data comprising at least respective occurrence location data, wherein the data sets correspond to a plurality of individuals occupying a building environment, and are continuously collected therefrom; applying an epidemiological monitoring query procedure comprising use of an application interface to query the data base at least with respect to location and occurrence timing of the health-related data; and presenting or outputting of the query results to provide a report, affording, at least in part, epidemiological and environmental monitoring and assessment.

Further aspects provide a system or computer apparatus for epidemiological and environmental monitoring and assessment, comprising: a computer having a processor and at least one storage device connected thereto; a database of health related data, comprising a stored set of a set of health-related occurrence data including respective occurrence dates, and wherein the data set corresponds to a plurality of individuals occupying a building environment, and is continuously collected therefrom; a database of building environment data, comprising a stored set of respective building environment data and comprising at least respective occurrence location data, and wherein the data set corresponds to that of a building environment, and is continuously collected therefrom; and a stored software program operative with the processor to receive and process a user's application of an epidemiological monitoring query procedure comprising use of an application interface to query the data base at least with respect to location and occurrence timing of the health-related data.

### BRIEF DESCRIPTION OF THE DRAWINGS

FIG. 1 shows an exemplary embodiment of the inventive system and method for proactive health and environmental monitoring and assessment.

FIG. 2 illustrates, according to an exemplary embodiment, a sample report (Report 1) showing Incident Rates for Body System=Rash (comprising seven individual rash symptoms according to the schema presented in Table 2 herein below), School Group=Elementary (comprising 8 schools out of a school district of 15 schools), Date Range=Jan. 1, 2005-Jan. 15, 2005. X axis=User selected range of dates. Y axis=Incidence Rate.

FIG. 3 illustrates, according to an exemplary embodiment, a sample report (Report 9) showing Incident Rates for Body System=Rash (comprising seven individual rash symptoms according to the schema presented in Table 2 herein below), School Group=Elementary (comprising 8 schools out of a school district of 15 schools), Date Range=Jan. 1, 2005-Jan. 15, 2005. X axis=Incidence Rates for individual schools in School Group Elementary. Y axis=Incidence Rate.

FIG. 4 illustrates, according to an exemplary embodiment, a sample report (Report 16) showing Incident Rates for Body System=Rash (comprising seven individual rash symptoms according to the schema presented in Table 2 herein below), School=Tarpy (comprising 1 elementary school out of a school district of 15 schools), Date Range=Jan. 1, 2005-Jan. 15, 2005. X axis=Incidence Rates for individual locations in School Tarpy, Y axis=Incidence Rate.

FIG. 5 illustrates, according to an exemplary embodiment, a sample report (Report 12) showing Incident Rates for Body System=Rash (comprising seven individual rash symptoms according to the schema presented in Table 2 herein below), School=Tarpy (comprising 1 elementary school out of a school district of 15 schools), Date Range=Jan. 1, 2005-Jan. 15, 2005. X axis=Incidence Rates for individual rash symptoms in Body System group Rash. Y axis=Incidence Rate.

FIG. 6 illustrates, according to an exemplary embodiment, a sample report (Report 3) showing Incident Rates for Body System=Rash (comprising seven individual rash symptoms according to the schema presented in Table 2 herein below), School=Sample (comprising 1 elementary school out of 8 comprising the group elementary schools, in a school district with a total of 15 schools), Date Range=Nov. 15, 2004-Dec. 15, 2004. X axis=User selected range of dates. Y axis=Incidence Rate.

FIG. 7 illustrates, according to an exemplary embodiment, results in a sample report (Report 9) showing Incident Rates for Body System=Rash (comprising seven individual rash symptoms according to the schema presented in Table 2 herein below), School Group=Elementary (comprising 8 schools out of a school district of 15 schools), Date Range=Nov. 28, 2005-Dec. 4, 2005. X axis=Incidence Rates for individual schools in School Group Elementary. Y axis=Incidence Rate.

### DETAILED DESCRIPTION OF THE INVENTION

The inventive systems and methods have many advantages over the art. For example, they can be used to identify excursions (e.g. departures), allowing immediate reactive response. Additionally, they can be used to identify trends, allowing proactive actions. Moreover, they can be used when trends or excursions occur, and the category or meaningful assembly of categories directs the nature of inquiries and remediative actions. For example, an increase in respiratory medical problems would direct inquiries to airborne toxins (and, for example, an increase in airborne toxins would direct inquiry into physical plant conditions, and/or incidence of respiratory medical problems or prevention thereof), while an increase in physical injuries may point to unsafe equipment (or, or example, the incidence of particular equipment may point to potential physical injuries). Furthermore, they can be used to establish baselines, so that action does not have to be taken if not needed.

The inventive analyses are applied to either a non-homogenous population, or a homogenous population. In particular aspects, the population is distributed among two or more locations allowing for inter- as well as intra-location evaluations, and thus increasing the power of the analysis by allowing rapid comparisons.

In particular embodiments, one or more frequent sources of frequent (e.g., continuous or substantially continuous) data regarding adverse health effects experienced by members of the population is available. Such data can be self-reported, or drawn from evaluations performed by medical professionals. Preferably, there is a continuous stream of health data, either self-reported or developed by medical professionals.

In particular aspects, one or more sources of data regarding environmental factors is available; such as, for example, the location at which the adverse health effect was recognized or experienced.

In particular aspects, collected health data is suitable for Statistical Process Control evaluation. In particular embodiments, it is categorized according to meaningful medical criteria. For example, school health room logs where nurses use a set of symptom codes are evaluated, or insurance codes or medicare codes are evaluated. With categorized data, the number of incidents in a category divided by the population gives an ‘incident rate.’ Yet another possibility is continuous data, such as body temperatures.

In preferred aspects, the overall approach to epidemiological and environmental monitoring comprises Statistical Process Control technology. The continuous source of data regarding adverse health effects experienced by members of the population is analyzed to determine the mean and range of variability of individual time-sequenced data points under ‘normal’ conditions. This is referred to as ‘establishing baseline conditions.’ Once baseline conditions are established, deviations from normality can be detected when new data points show one of several recognized patterns of behavior in which the average, mean or both shift from the baseline conditions. Where the population is distributed among two or more locations, a complementary method of identifying deviations from normality is to compare the locations to each other. The advantage of this complementary method is that, where the locations have a similar populations, it identifies deviations more quickly, and with fewer data points.

According to particular aspects, deviations in the adverse health effect incidence rate provide important information allowing for decision making by entities responsible for the locations housing the population.

For example, where a mild increasing trend is observed, resources are allocated to take proactive steps before the incidence rate(s) of the adverse health effect(s) exceed(s) acceptable levels.

For example, where a pronounced increase is observed, resources are allocated to take reactive steps to lower the incidence rate(s) of the adverse health effect(s) to acceptable levels.

When increasing trends are observed, the categorization of symptoms according to meaningful medical criteria provides important information regarding potential causative agents, thereby allowing optimum allocation of resources to alleviate the trend. For example, an increase in symptoms associated with the respiratory system suggests an inhaled agent. Resources would be allocated to give priority to identifying airborne materials at associated locations. For example, an increase in symptoms associated with the gastrointestinal tract suggests an ingested agent. Resources would be allocated to give priority to identifying foodborne illnesses at associated locations.

In particular aspects, where one or more steps are taken to ameliorate a potential adverse health effect causative factor, the success of the step is evaluated by observing a downward trend.

In particular aspects, where members of a population at one location are concerned about adverse health effects, then evaluation of the trends at that location can confirm or rebut their assertions.

Minimum environmental factors. The mere fact that a trend is observed in an adverse health effect incidence rate can prompt an investigation. For an effective investigation, a minimum environmental factor data must be associated with the adverse health effect (e.g., the location where it was experienced). The scope of the investigation may be expanded to include other appropriate environmental factors.

Significantly, the utility/power of the epidemiological and environmental monitoring tool is enhanced where additional sources of data regarding environmental factors are included in the analysis. While there are many kinds of environmental factor data, they must have a common associated time and location for each data point, to enable integration into the epidemiological and environmental monitoring system and method.

Examples of environmental factor data include but are not limited to: data that directly measures environmental conditions at the specified locations (e.g., temperature, humidity, carbon dioxide levels, HVAC timing and fan settings as indicators of indoor air quality and comfort); data measuring factors that may indirectly affect environmental conditions at the specified locations (e.g., HVAC maintenance logs, building envelope repair records, purchase orders for new building materials, pesticide application contracts, and janitorial SOP instructions); and data that directly measures environmental risks (e.g., measurements for specific toxins such as mold, second-hand cigarette smoke, lead based paint, asbestos, and chemical vapors).

Definitions:

“Building environment” as used herein refers to the physical environment of one or more buildings, and also encompasses associated outdoor spaces and environs that are at least occasionally occupied by building occupants, or that are in environmental or physical communication with the one or more buildings. The one or more buildings can be connected, grouped within a specific region, or can be spread between or among one or more separate regions. The building environment may be occupied by a homogeneous or non-homogeneous population of individuals or occupants. A school district comprising multiple schools is an example of a building environment.

Data “continuously collected from the building environment” as used herein refers to on-going data collection (e.g., repeated, frequent, continuous, hourly, daily, weekly, monthly, yearly, etc.) from the building environment. “Occurrence data” and as used herein refers to data associated with or corresponding to particular health-related incidences, symptoms or conditions. “Occurrence location data” as used herein refers to physical location of respective occurrences.

“Homogeneous or substantially homogenous population of similarly situated individuals” as used herein refers to a population of building environment occupants having on or more common characteristics (e.g., including, but not limited to age, sex, pre-existing health conditions, profession or non-professional occupation, students, soldiers, etc.).

Particular aspects of the present invention provide a continuous epidemiological and environmental monitoring system, comprising:

data generation (e.g., continuous collection of health-related and environmental data related thereto);

central database repository of collected data;

epidemiological monitoring query procedure, wherein data within the database is queried by an application interface; and

presentation of data (e.g., presentation of query results in graphic or tabular form).

Data generation. In particular aspects for data generation (e.g., collection), each location has a means to electronically collect adverse health effect incidence data. In particular embodiments, collection is by means of a health log, or medical records. Alternatively, other methods are contemplated, and there are no limitations on how the data are collected. Preferably, collection of data is in a timely (e.g., frequent, continuous, etc.) fashion. Preferably, the collection frequency (e.g., time course) is short compared to onset of acute diseases represented by the collected health-related data. Preferably, data collection is by electronic means. Data can be self-reported, self-reported with the mediation of, for example, a trained medical professional (e.g., a school nurse), or developed, for example, by a physician (diagnosis).

To calculate health effect incidence rate, health effects are preferably and optimally categorized. A variety of schemes have utility in the present context. For example, ‘codes’ used by medicare or insurance companies are usable, providing a relatively ‘granular’ division of health effects. Alternatively, simple notations used by nurses in school health rooms, such as SA=Stomachache, HA=headache have substantial utility.

Examples of a complete health effect, environmental location and outcome code scheme appropriate for use by school nurses are provided in TABLES 1 through 5 herein below. Preferably, the scheme is appropriate to the level of medical training of the person who is collecting the data. Preferably, each location also has a means to electronically collect environmental factor data (e.g., location related data, etc.). However, there are many ways/schemes/means for data collection.

Central database repository: In particular aspects, all data is collected in a central database repository (e.g. one or more databases at one location). Alternatively, data is collected in a ‘central’ repository database comprising multiple databases from several locations.

Epidemiological monitoring query procedure: In particular aspects, data within the database is queried by an ‘application interface.’

“Application interface” as used herein refers to a computer graphical interface that allows a user to communicate with an underlying program which performs the data storage and manipulation functions for, for example, reported health symptom and environmental measurement data. An example of a graphical interface would be an Active Server Page (ASP) viewed in a web browser, where the ASP page is a hypertext markup language (HTML) page containing one or more scripts (small embedded programs), though other methods are allowed and there are no limitations on how the application interface is constructed. The small scripts can be used to invoke functions in the underlying program which performs the data storage and manipulation functions. An example of an underlying program would be one written in Structured Query Language (SQL), though other programming environments are allowed. The functions which are invoked allow the user to select all or portions of the health symptom and/or environmental data, and order the data according to a desired criteria such as time, location, symptom, body system, environmental variable, or other such criteria as would be beneficial in identifying trends, patterns and relationships.

In particular exemplary embodiments, the queries are constructed based on three broad categories (comparison, Statistical Process Control, and advanced Correlation Analysis). First, in simple comparison, data are displayed as simple histograms allowing visual evaluation. For example, the adverse health effects are compared between two locations, or different adverse health effects can be compared within one location. The query returns data selected based on choices regarding the time range, adverse health effect, and location.

Second, in Statistical Process Control, data are displayed, for example, as ‘run charts’, with a mean and upper/lower control limits based on normal variation. Trends can be identified by well established rules regarding how the pattern of data points behaves over time. Again, the query returns data selected based on choices regarding the time range, adverse health effect, and location. Preferably, a data analysis application is used which can apply Statistical Process Control across all categories, or meaningful assemblies of categories.

Third, in advanced Correlation Analysis, where disparate environmental factor data is available, queries can be constructed based on multivariate statistics supplemented, if necessary, by advanced statistical pattern recognition methodologies (e.g., Bayesian analysis). The structure of the query will be based on the pattern recognition methodology selected, as will graphical presentation of the results.

Presentation of data. The results of the query can be presented, for example graphically, or in tabular form. In either case, the results can appear on a computer screen and/or be printed out. Preferably, presentation of data to users is according to standard SPC charting techniques.

For standalone presentation, the results of the query can be portrayed on the same computer where the database is housed.

For intranet presentation, the results of the query can be portrayed on any computer which has access over a local or distributed network which includes the computer or server upon which the database is housed.

For internet presentation, the results of the query can be portrayed on any computer that can access the computer or server upon which the database is housed over the internet.

Exemplary Health monitoring embodiment. In a particular embodiment, the inventive system and method provides an epidemiology monitoring and assessment system. In such embodiments, collection of categorized health data on a periodic or continuous basis is suitable for application of Statistical Process Control.

Statistical Process Control is an art-recognized method of detecting non-random trends and abberant patterns. When a trend is detected indicating an increase in an adverse health outcome, resources can be allocated to take proactive steps before the incidence rate(s) of the adverse health effect(s) exceed(s) acceptable levels. Statistical Process Control provides clear criteria for identifying an aberrant pattern (e.g., an incidence rate more than 3 standard deviations away from historical averages), allowing resources to be rapidly allocated to take reactive steps to lower the incidence rate(s) of the adverse health effect(s) to acceptable levels.

Specific Eexemplary Embodiments:

Particular aspects provide a method for epidemiological and environmental monitoring and assessment, comprising: configuring, in one or a plurality of electronic databases stored in a storage device of a computer, a set of health-related occurrence data including respective occurrence dates, and a respective set of building environment data comprising at least respective occurrence location data, wherein the data sets correspond to a plurality of individuals occupying a building environment, and are continuously collected therefrom; applying an epidemiological monitoring query procedure comprising use of an application interface to query the data base at least with respect to location and occurrence timing of the health-related data; and presenting or outputting of the query results to provide a report, affording, at least in part, epidemiological and environmental monitoring and assessment. In particular aspects, the health-related occurrence data is categorized according to a method selected from the group consisting of body systems and body system codes, symptoms and symptom codes, treatments and treatment codes, art-recognized medical criteria and codes, disposition and disposition codes, and combinations thereof. In particular aspects, applying an epidemiological monitoring query procedure comprises use of at least one method selected from the group consisting of comparison, statistical process control, and advanced correlation analysis. In particular aspects, trends or excursions are identified. In alternate aspects, the building environment data further comprises at least one data measurement selected from the monitoring group consisting of temperature, relative humidity, CO₂ concentration, CO concentration, particulate matter, allergens, fumes, toxins, airborne microbes, molds, chemicals, microbes, data that directly measures environmental conditions, data measuring factors that may indirectly affect environmental conditions, and data that directly measures environmental risks.

Preferably, the epidemiological and environmental monitoring and assessment is proactive. In particular aspects, the occurrence location data comprises data selected from the group consisting of building environment designation, building designation, room or environ designation, and combinations thereof. In particular aspects, the individuals occupying the building environment represent a homogeneous or substantially homogenous population of similarly situated individuals. In particular aspects, the individuals occupying the building environment are spread among several locations, allowing for inter-location evaluation, intra-location evaluation, or both. In particular aspects, the environmental data has a common associated time and location for each data point.

Preferably, the frequency of health-related data collection is short compared to onset of occurrence-related symptoms. In particular aspects, the method comprises determining incidence rates of respective symptoms and establishing a proactive or remedial baseline or threshold value for respective symptom incidence rates. Preferably, the method further comprising proactive intervention. Alternately, the method further comprises remedial intervention.

Further aspects provide a system or computer apparatus for epidemiological and environmental monitoring and assessment, comprising: a computer having a processor and at least one storage device connected thereto; a database of health related data, comprising a stored set of a set of health-related occurrence data including respective occurrence dates, and wherein the data set corresponds to a plurality of individuals occupying a building environment, and is continuously collected therefrom; a database of building environment data, comprising a stored set of respective building environment data and comprising at least respective occurrence location data, and wherein the data set corresponds to that of a building environment, and is continuously collected therefrom; and a stored software program operative with the processor to receive and process a user's application of an epidemiological monitoring query procedure comprising use of an application interface to query the data base at least with respect to location and occurrence timing of the health-related data.

In particular aspects, the health-related occurrence data is categorized according to a method selected from the group consisting of body systems and body system codes, symptoms and symptom codes, treatments and treatment codes, art-recognized medical criteria and codes, disposition s and disposition codes, and combinations thereof. In particular aspects, applying an epidemiological monitoring query procedure comprises use of at least one method selected from the group consisting of comparison, statistical process control, and advanced correlation analysis.

In particular aspects, trends or excursions are identified. In particular aspects, the building environment data further comprises at least one data measurement selected from the monitoring group consisting of temperature, relative humidity, CO₂ concentration, CO concentration, particulate matter, allergens, fumes, toxins, airborne microbes, molds, chemicals, microbes, data that directly measures environmental conditions, data measuring factors that may indirectly affect environmental conditions, and data that directly measures environmental risks.

Preferably, the epidemiological and environmental monitoring and assessment is proactive. In particular aspects, the occurrence location data comprises data selected from the group consisting of building environment designation, building designation, room or environ designation, and combinations thereof. In particular aspects, the individuals occupying the building environment represent a homogeneous or substantially homogenous population of similarly situated individuals. In particular aspects, the individuals occupying the building environment are spread among several locations, allowing for inter-location evaluation, intra-location evaluation, or both. In particular aspects, the environmental data has a common associated time and location for each data point.

Preferably, the frequency of health-related data collection is short compared to onset of occurrence-related symptoms. In particular aspects, the system comprises determining incidence rates of respective symptoms and establishment of a proactive or remedial baseline or threshold value for respective symptom incidence rates. Preferably the system further comprises proactive intervention. Alternately, the system further comprises remedial intervention.

The present invention is further illustrated by reference to the EXAMPLES below. However, it should be noted that these EXAMPLES, like the embodiments described above, are illustrative, and are not to be construed as restricting the enabled scope of the claimed aspects of the invention in any way.

### EXAMPLE I

(The inventive epidemiological and environmental monitoring and assessment system and method was implemented and shown to have substantial utility in a school setting)

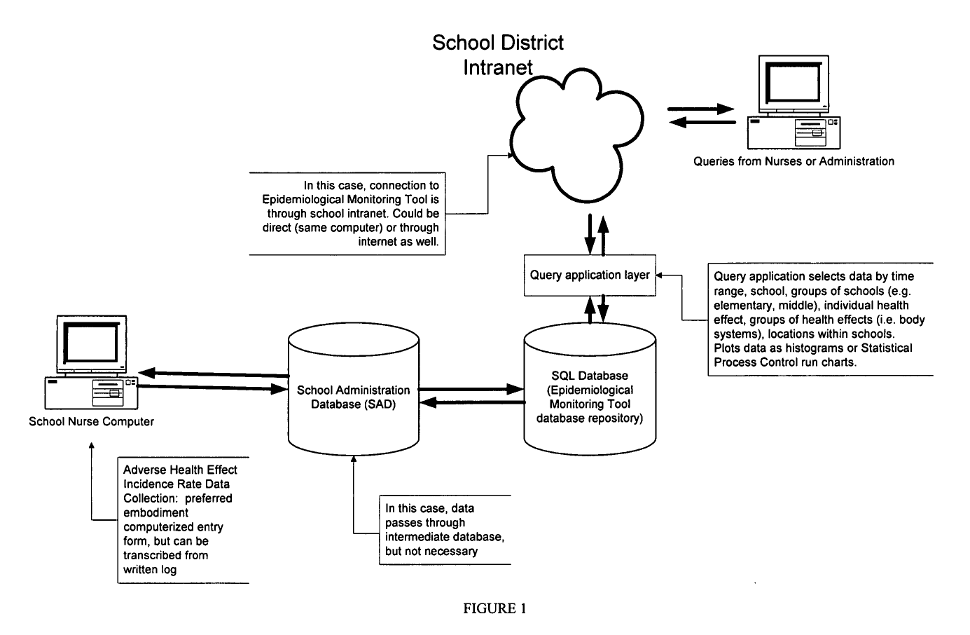

A preferred embodiment is described and understood with reference to FIG. 1.

A group of schools within a school district meets the criteria of being a population distributed among two or more locations. At each school, students who have adverse health effects (feel ill or are injured) report to a health room staffed by a nurse or health technician. All incidences are recorded on a health log, which provides a continuous source of self-reported data regarding adverse health effects experienced by members of the population. The health log records environmental factor data, minimally including the position of the incident within the location.

A preferred embodiment was used at a school district comprising three high schools, four middle schools, and eight elementary schools. To implement the exemplary epidemiological and environmental monitoring and assessment system and method, the paper health log formerly used at the school district was converted to electronic form. A set of 63 symptom codes was prepared (TABLE 1) covering the vast majority of symptoms and illnesses reported by school children. In this instance, the codes were defined by nurses, and thus are consistent with the level of description that they are legally able to provide (less than a diagnosis such as a physician might provide).

Optionally, to provide additional interpretive power, the symptoms were also assigned to body system groups (TABLES 1 and 2). Thus, symptoms such as coughing, runny nose, dry throat, etc., were assigned to the ‘respiratory’ body system. Furthermore, location codes (TABLE 3), treatment codes (TABLE 4) and disposition codes (TABLE 5) were established.

TABLE 1
Exemplary symptom codes covering the majority of
symptoms reported by school children

| Sym | | Body System |
|---|---|---|
| Code | Symptom | Group |
| ANXIO | Anxious | Social |
| BEE | Bee sting | Other |
| BITE | Animal, human or insect bite | Other |
| BREAT | Difficulty breathing | Respiratory |
| BRUIS | Bruise | Injury |
| BURN | Burn | Injury |
| CHEST | Chest tightness | Respiratory |
| COF | Cough, no sore throat | Respiratory |
| COFST | Coughing with sore throat | Respiratory |
| DENTL | Orthodontia or other non-tooth dental | Other |
| DIABE | Diabetic symptoms | Other |
| DIARR | Diarrhea | Gastrointestinal |
| DIZZY | Dizzy/loss of balance | Neurological |
| EAR | Earache | Ear |
| EYDRY | Dry eyes | Eye |
| EYINJ | Eye injury | Injury |
| EYNOD | Red eye without drainage | Eye |
| EYOBJ | Object in eye | Injury |
| EYWD | Red eye with drainage | Eye |
| FAINT | Feels faint or fainted | Nerological |
| HA | Headache | Nerological |
| HEAD | Head injury | Injury |
| HEAR | Difficulty hearing | Ear |
| HUNGR | Hungry | Social |
| ITCHL | Itching, limited or no color, localized | Rash |
| ITCHW | Itching, limited or no color, widespread | Rash |
| LICE | Lice, head | Other |
| MENST | Menstrual cramps or feminine products | Other |
| MTAST | Metallic taste | Nerological |
| NASAL | Congested nose | Respiratory |
| NAUS | Nausea | Gastrointestinal |
| NBINJ | Nosebleed, injury | Injury |
| NBNON | Nosebleed, non-injury | Other |
| NUMB | Numbness | Nerological |
| NV | Nausea with vomiting | Gastrointestinal |
| NVH | Nausea with vomiting & headache | Gastrointestinal |
| OTHER | Other, see notes | Other |
| PAINJ | Pain, joint | Injury |
| PAINM | Pain, muscle | Injury |
| PAINO | Pain, other | Injury |
| PALE | Pale and/or clammy | Other |
| RSHLB | Rash, localized, with bumps or blisters | Rash |
| RSHLF | Rash, localized & flat | Rash |
| RSHO | Rash, other | Rash |
| RSHWB | Rash, widespread, with bumps or blisters | Rash |
| RSHWF | Rash, widespread & flat | Rash |
| SA | Stomachache | Gastrointestinal |
| SAHA | Stomachache with headache | Gastrointestinal |
| SEIZE | Seizure | Nerological |
| SLIVR | Sliver | Injury |
| SOIL | Soiling accident | Social |
| ST | Sore throat | Respiratory |
| SWELL | Swelling | Injury |
| T | Feels warm or cold | Other |
| TEETH | Tooth lost or loose, non-injury | Other |
| TIRED | Tired or fatigued | Other |
| TOACH | Toothache | Other |
| TOINJ | Tooth injury | Injury |
| VISIO | Vision changes | Other |
| WHEEZ | Wheezing | Respiratory |
| WOCUT | Wound, cut | Injury |
| WOPUN | Wound, puncture | Injury |
| WOSCR | Wound, abrasion | Injury |

TABLE 2
Exemplary symptom codes covering the majority of symptoms
reported by school children grouped into
body systems, facilitating interpretive analysis as to causes.

| | Sym | |
|---|---|---|
| Body System | Code | Symptom |
| Ear | EAR | Earache |
| Ear | HEAR | Difficulty hearing |
| Eye | EYDRY | Dry eyes |
| Eye | EYNOD | Red eye without drainage |
| Eye | EYWD | Red eye with drainage |
| Gastrointestinal | DIARR | Diarrhea |
| Gastrointestinal | NAUS | Nausea |
| Gastrointestinal | NV | Nausea with vomiting |
| Gastrointestinal | NVH | Nausea with vomiting & headache |
| Gastrointestinal | SA | Stomachache |
| Gastrointestinal | SAHA | Stomachache with headache |
| Injury | BRUIS | Bruise |
| Injury | BURN | Burn |
| Injury | EYINJ | Eye injury |
| Injury | EYOBJ | Object in eye |
| Injury | HEAD | Head injury |
| Injury | NBINJ | Nosebleed, injury |
| Injury | PAINJ | Pain, joint |
| Injury | PAINM | Pain, muscle |
| Injury | PAINO | Pain, other |
| Injury | SLIVR | Sliver |
| Injury | SWELL | Swelling |
| Injury | TOINJ | Tooth injury |
| Injury | WOCUT | Wound, cut |
| Injury | WOPUN | Wound, puncture |
| Injury | WOSCR | Wound, abrasion |
| Neurological | DIZZY | Dizzy/loss of balance |
| Neurological | FAINT | Feels faint or fainted |
| Neurological | HA | Headache |
| Neurological | MTAST | Metallic taste |
| Neurological | NUMB | Numbness |
| Neurological | SEIZE | Seizure |
| Other | BEE | Bee sting |
| Other | BITE | Animal, human or insect bite |
| Other | DENTL | Orthodontia or other non-tooth dental |
| Other | DIABE | Diabetic symptoms |
| Other | LICE | Lice, head |
| Other | MENST | Menstrual cramps or feminine products |
| Other | NBNON | Nosebleed, non-injury |
| Other | OTHER | Other, see notes |
| Other | PALE | Pale and/or clammy |
| Other | T | Feels warm or cold |
| Other | TEETH | Tooth lost or loose, non-injury |
| Other | TIRED | Tired or fatigued |
| Other | TOACH | Toothache |
| Other | VISIO | Vision changes |
| Rash | ITCHL | Itching, limited or no color, localized |
| Rash | ITCHW | Itching, limited or no color, widespread |
| Rash | RSHLB | Rash, localized, with bumps or blisters |
| Rash | RSHLF | Rash, localized & flat |
| Rash | RSHO | Rash, other |
| Rash | RSHWB | Rash, widespread, with bumps or blisters |
| Rash | RSHWF | Rash, widespread & flat |
| Respiratory | BREAT | Difficulty breathing |
| Respiratory | CHEST | Chest tightness |
| Respiratory | COF | Cough, no sore throat |
| Respiratory | COFST | Coughing with sore throat |
| Respiratory | NASAL | Congested nose |
| Respiratory | ST | Sore throat |
| Respiratory | WHEEZ | Wheezing |
| Social | ANXIO | Anxious |
| Social | HUNGR | Hungry |
| Social | SOIL | Soiling accident |

TABLE 3
Exemplary location codes covering common and
school specific locations. Use of location codes
facilitates interpretive analysis as to causes.

| Loc Code | Location |
|---|---|
| ART | Art room |
| AUDIT | Auditorium |
| BAND | Band |
| BATH | Bathroom |
| BUS | Bus |
| CHOR | Choir |
| COMNS | Commons |
| CONF | Conference room |
| COUNS | Counselor's Office |
| FIELD | Field |
| GYM | Gym |
| HALL | Hall |
| HOME | Home |
| HMART | Home arts |
| LIBRY | Library |
| LUNCH | Lunchroom |
| MUSIC | Music room |
| OFFIC | Office |
| PARK | Parking lot |
| PHOTO | Photo lab |
| PGD | Playground |
| PGDEQ | Playground equipment |
| POOL | Pool |
| SCI | Science Class |
| SHOP | Shop |
| STAFF | Staff lounge |
| WKRM | Workroom |
| ZRM1 | Classroom |
| ZRM2 | Classroom |
| ZRM3 | Classroom |
| ZRM4 | Classroom |
| ZRM5 | Classroom |
| ZRM6 | Classroom |
| ZRM7 | Classroom |
| ZRM8 | Classroom |
| ZRM9 | Classroom |
| ZRM10 | Classroom |
| ZRM11 | Classroom |
| ZRM12 | Classroom |
| ZRM13 | Classroom |
| ZRM14 | Classroom |
| ZRM15 | Classroom |
| ZRM16 | Classroom |
| ZRM17 | Classroom |
| ZRM18 | Classroom |
| ZRM19 | Classroom |
| ZRM20 | Classroom |
| ZRM21 | Classroom |
| ZRM22 | Classroom |
| ZRM23 | Classroom |
| ZRM24 | Classroom |
| ZRM25 | Classroom |
| ZRM26 | Classroom |
| ZRM27 | Classroom |
| ZRM28 | Classroom |
| ZRM29 | Classroom |
| ZRM30 | Classroom |
| ZRM31 | Classroom |
| ZRM32 | Classroom |
| ZRM33 | Classroom |
| ZRM34 | Classroom |
| ZRM35 | Classroom |
| ZRM36 | Classroom |
| ZRM37 | Classroom |
| ZRM38 | Classroom |
| ZRM39 | Classroom |
| ZRM40 | Classroom |
| ZRM41 | Classroom |
| ZRM42 | Classroom |
| ZRM43 | Classroom |
| ZRM44 | Classroom |
| ZRM45 | Classroom |
| ZRM46 | Classroom |
| ZRM47 | Classroom |
| ZRM48 | Classroom |
| ZRM49 | Classroom |
| ZRM50 | Classroom |
| ZRM51 | Classroom |
| ZRM52 | Classroom |
| ZRM53 | Classroom |
| ZRM54 | Classroom |
| ZRM55 | Classroom |
| ZRM56 | Classroom |
| ZRM57 | Classroom |
| ZRM58 | Classroom |
| ZRM59 | Classroom |
| ZRM60 | Classroom |
| ZRM61 | Classroom |
| ZRM62 | Classroom |
| ZRM63 | Classroom |
| ZRM64 | Classroom |
| ZRM65 | Classroom |
| ZRM66 | Classroom |
| ZRM67 | Classroom |
| ZRM68 | Classroom |
| ZRM69 | Classroom |
| ZRM70 | Classroom |
| ZRM71 | Classroom |
| ZRM72 | Classroom |
| ZRM73 | Classroom |
| ZRM74 | Classroom |
| ZRM75 | Classroom |

TABLE 4
Treatment codes covering the majority of treatments used to
alleviate symptoms reported by school children.

| Treatment | |
|---|---|
| Code | Treatment |
| BEE | Bee sting care |
| CLOTH | Change clothes |
| COLDW | Cold water rinse |
| EYRNS | Eye rinse |
| ICE | Ice |
| INHAL | Administer inhaler |
| MEDS | Administer medications |
| OBSRV | Observation |
| OTHER | Other, see comments |
| PRES | Pressure |
| REST | Rest |
| RICE | Rest, ice |
| RIELV | Rest, ice, elevation |
| RIES | Rest, ice, elevation, splint |
| RSTRM | Used restroom |
| SEIZE | Seizure care |
| SNACK | Snack |
| WOICE | Wound care, ice |
| WOUND | Wound care |

TABLE 5
Disposition codes covering the final outcome of a
visit to the school nurse by a school child.

| Disposition | |
|---|---|
| Code | Disposition |
| 911AP | 911, adult pickup |
| 911TR | 911, transport |
| B | Back to Class |
| BNOTE | Back to Class, note to parent, |
| BPC | Back to Class, parent contact |
| BPCHC | Back to Class, parent contact, |
| | referred to health care provider |
| BPCIR | Back to Class, parent contact, Incident Report, |
| HOME | OK for student to go home |
| OTHER | Other |
| PAP | Parent contact, adult pickup |
| PAPIR | Parent contact, adult pickup, Incident Report |
| PAPNT | Parent contact, adult pickup, note home |
| PCNOT | Attempted parent contact, see comments |
| PGOHM | Parent contact, OK for student to go home |
| PHC | Parent contact, referred to health care provider |
| PHCAP | Parent contact, referred to |
| | health care provider, adult pickup |
| PIR | Parent contact, Incident Report |

The health log also records environmental factor data such where the affected student was within the school (position within location), according to the schema shown in TABLE 3.

The health log data was collected by modifying a school student information administrative database. However, this database was not suited to performing the statistical analysis required for the epidemiological monitoring tool. Therefore, the health log data was exported to another database. In this instance, it is a SQL database, though many other types of database products have the inherent functionality to accomplish the task. SQL databases are based on Structure Query Language. Relational database programs, such as Oracle™ or MySQL™, recognize this language. A user can write SQL scripts that create databases and tables, insert data into databases, and draw that data back out. Each database program utilizes a different version of SQL, but most are very similar as recognized in the art, so once you learn SQL on one database, it is not difficult to use it on others.

An application procedure was built in a SQL database. The procedure accepts inputs from users regarding the time range, school (or schools, such as all elementary schools), health effect of interest (or body system of interest), and position within the school. The user can select which variable is portrayed as the ‘x’ axis, and which is the ‘y’ axis. A list of possible reports is provided herein below:

List of Exemplary Reports:

All graphs may be displayed using commonly accepted formats including line or bar style. The selection is one of convenience to the user, and to choose one does not exclude other forms of representation. The “Y” axis may represent the incidence rate for either a selected Symptom or a group of symptoms known as a Body System. The “X” axis is selected, for example, as time, or as one of the categories of general location (e.g., school), specific location (e.g., room), symptom (e.g., members of the group composing a Body System). The user selects filtering criteria including: (1) the time period; (2) the school or school group; (3) the location or all locations; and (4) the symptom or group of symptoms known as a body system. Exemplary Exemplary reports showing these choices are as follows.

1. Line Statistical Process Control Chart: Y axis=Incident Rate for Selected Symptom, for selected School Group, for all Locations; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

2. Line form of Statistical Process Control Chart: Y axis=Incident Rate for Selected Symptom, for selected School, for all Locations; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

3. Statistical Process Control Chart: Y axis=Incident Rate for Selected Body System, for selected School, for all Locations; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

4. Line Statistical Process Control Chart: Y axis=Incident Rate for Selected Body System, for selected School Group, for all Locations; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

5. Line Statistical Process Control Chart: Y axis=Incident Rate for Selected Symptom, for selected School, for selected Location; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

6. Line Statistical Process Control Chart: Y axis=Incident Rate for Selected Body System, for selected School, for selected Location; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

7. Line Statistical Process Control Chart: Y axis=Incident Rate for Selected Body System, for selected School Group, for selected Location; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

8. Line Statistical Process Control Chart: Y axis=Incident Rate for Selected Symptom, for selected School Group, for selected Location; X axis=Selected Time Range

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

9. Bar Chart: Y axis=Incident Rate for Selected Body System, for selected School Group; X axis=Categorical, individual Schools within School Group

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

10. Bar Chart: Y axis=Incident Rate for Selected Symptom, for selected School Group; X axis=Categorical, individual Schools within School Group

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

11. Bar Chart: Y axis=Incident Rate for Symptoms within Selected Body System, for selected School Group, any Location; X axis=Categorical, individual Symptoms within Body System

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

12. Bar Chart: Y axis=Incident Rate for Symptoms within Selected Body System, for selected School, any Location; X axis=Categorical, individual Symptoms within Body System

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

13. Bar Chart: Y axis=Incident Rate for Symptoms within Selected Body System, for selected School Group, for selected Location; X axis=Categorical, individual Symptoms within Body System

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

14. Bar Chart: Y axis=Incident Rate for Symptoms within Selected Body System, for selected School, for selected Location; X axis=Categorical, individual Symptoms within Body System

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

15. Bar Chart: Y axis=Incident Rate for Selected Body System, for selected School Group; X axis=Categorical, individual Locations

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

16. Bar Chart: Y axis=Incident Rate for Selected Body System, for selected School; X axis=Categorical, individual Locations

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

17. Bar Chart: Y axis=Incident Rate for Selected Symptom, for selected School Group; X axis=Categorical, individual Locations

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals).

18. Bar Chart: Y axis=Incident Rate for Selected Symptom, for selected School; X axis=Categorical, individual Locations.

a. Default Selected Time Range: 1 week

b. Other time range presets: 1 month, year to date

c. User selected time range

d. 30 day moving average of selected symptom incidence rate (does not to exclude other averaging intervals)

e. 30 day upper control limit, here set at three times the standard deviation of the symptom incidence rates within this period (does not to exclude other calculation intervals)

To generate the graphs, for example, an art-recognized charting application (e.g., ChartDirector™) was used in conjunction with an SQL procedure.

Access to the SQL procedure (and thus the entire environmental monitoring tool) can be, for example, through a browser interface. Simple ASP calls invoke the SQL procedure/ChartDirector™ interface. In the present embodiment, the invocation is done by accessing the SQL database through a school district wide intranet. However, the connection could also be done directly (on the computer where the SQL database resides), or remotely through the internet (with the addition of web server software).

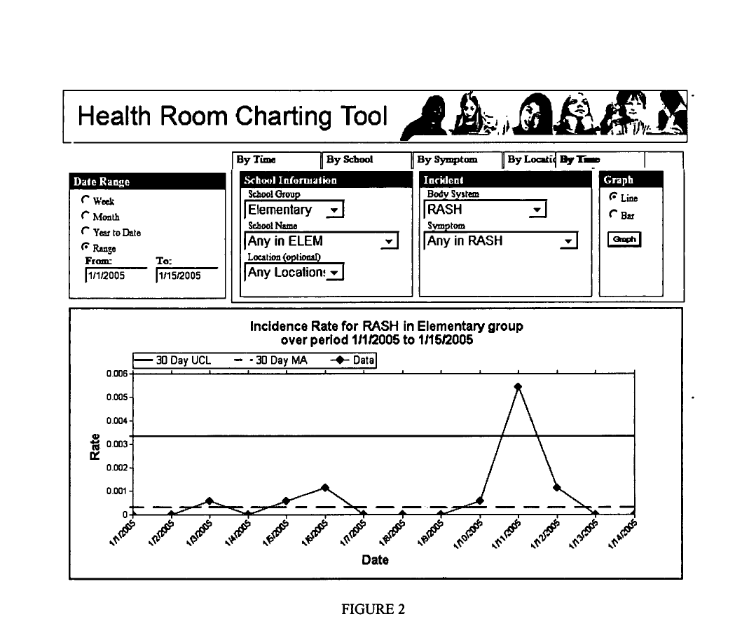

An exemplary case shows how the epidemiological and environmental monitoring and assessment system and method was applied in the school district. Analyzing data by time is one of the ways to identify trends or abnormal situations. During the first week after the winter break, a high number of rashes were reported at one of the elementary schools in a district. The epidemiological and environmental monitoring and assessment system indicated that the incidence rate was significantly greater than the historical average. This can be seen in FIG. 2, which shows, according to an exemplary embodiment, a sample Report 1 (see above): Incident Rates for Body System=Rash (comprising seven individual rash symptoms according to the schema presented in Table 2), School Group=Elementary (comprising 8 schools out of a school district of 15 schools), Date Range=Jan. 1, 2005-Jan. 15, 2005. X axis=User selected range of dates. Y axis=Incidence Rate. From FIG. 2 it can be seen that the incidence rate for the body system rash exceeds the upper control limit (in this instance defined as 3-times the standard deviation of measurements made during the last 30 day period) during the selected time period. This constituted an aberrant increase, and it was desirable to take reactive steps to lower the incidence rate of the rash symptoms to acceptable levels.

To develop further information to properly allocate resources, the data analysis features of the epidemiological and environmental monitoring and assessment system were selected to display a comparison of schools within the group Elementary Schools. This was done to determine if the increase in the incidence rate of the body system Rash observed in FIG. 2 was a localized trend or a general trend.

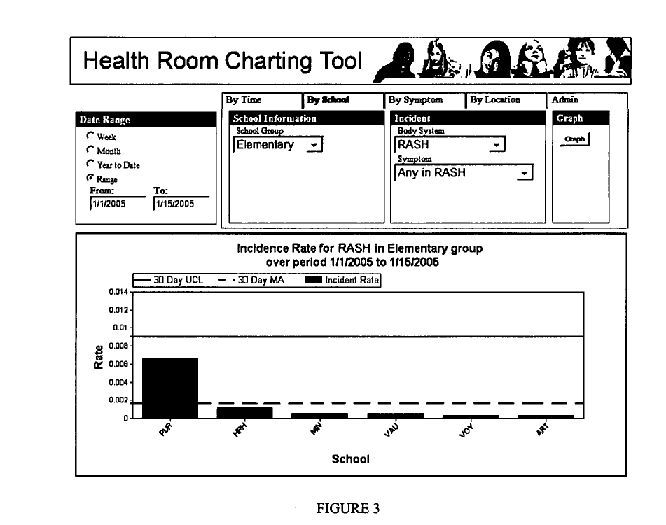

FIG. 3 shows the results, according to an exemplary embodiment, in a sample Report 9: Incident Rates for Body System=Rash (comprising seven individual rash symptoms according to the schema presented in Table 2), School Group=Elementary (comprising 8 schools out of a school district of 15 schools), Date Range=Jan. 1, 2005-Jan. 15, 2005. X axis=Incidence Rates for individual schools in School Group Elementary. Y axis=Incidence Rate. As shown in FIG. 3, the epidemiological and environmental monitoring and assessment system revealed that the incident rate at the elementary school with the identifying code “PUR” was well above what the others in the district were reporting. Thus, it was concluded that the increase was a localized trend and that resources should be allocated to investigate the elementary school “PUR”.

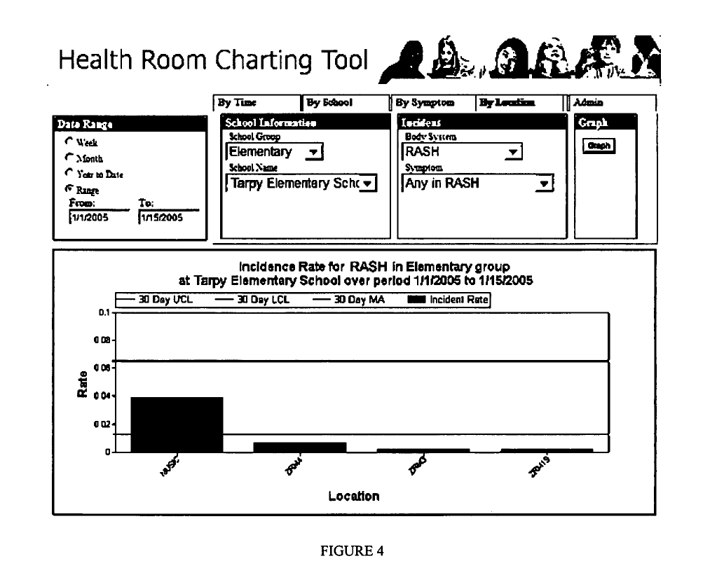

To provide additional information to effectively allocate resources, within the elementary school identified with the code “PUR,” the epidemiological and environmental monitoring and assessment system was set to show the environmental variable “location”. FIG. 4 shows the results, according to an exemplary embodiment, in a sample Report 16: Incident Rates for Body System=Rash (comprising seven individual rash symptoms according to the schema presented in TABLE 2), School=Tarpy (corresponding to the identifying code “PUR” and comprising 1 elementary school out of a school district of 15 schools), Date Range=Jan. 1, 2005-Jan. 15, 2005. X axis=Incidence Rates for individual locations in School Tarpy, Y axis=Incidence Rate. The analysis shown in FIG. 4 revealed that the rashes were virtually all from the same room, “MUSIC”. In this case, the room was adjacent to a substantial remodeling project taking place in the school.

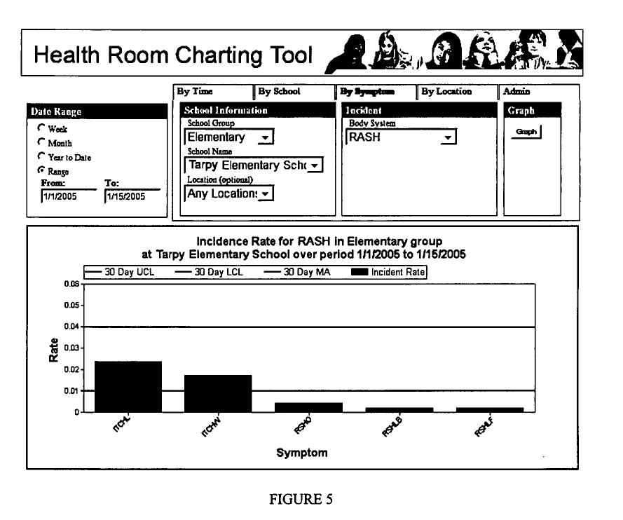

To provide additional information to effectively allocate resources, within the elementary school identified with the code “PUR,” the epidemiological and environmental monitoring and assessment system was set to show the incidence rates for individual symptoms within the body system “Rash”. FIG. 5 shows the results, according to an exemplary embodiment, a sample Report 12: Incident Rates for Body System=Rash (comprising seven individual rash symptoms according to the schema presented in Table 2), School=Tarpy (comprising 1 elementary school out of a school district of 15 schools), Date Range=Jan. 1, 2005-Jan. 15, 2005. X axis=User Incidence Rates for individual rash symptoms in Body System group Rash. Y axis=Incidence Rate. As shown in FIG. 5, when the body system “rash” was broken out into its component symptoms, the majority were seen to be itching (local and widespread), rather than rash with redness w/ or w/o bumps. Itching is a momentary effect, suggesting a physically irritating agent, unlike rashes with redness, which suggest more toxic etiological agents.

As a result of the information developed by the epidemiological and environmental monitoring and assessment system, an environmental investigation focused on the possibility of irritating compounds from a remodeling project adjacent to the Music room. The investigation found that there was a breach into the attic crawlspace in a loft area. The construction crew had blanked off the HVAC return air ducts, but left the supply ducts open, creating a situation where the occupied room was under negative pressure relative to the construction zone. Air flowed through the breach into the occupied room. Air samples showed that it may have carried some fiberglass insulation fibers, a known dermal irritant. When the air path was blocked, the symptoms subsided.

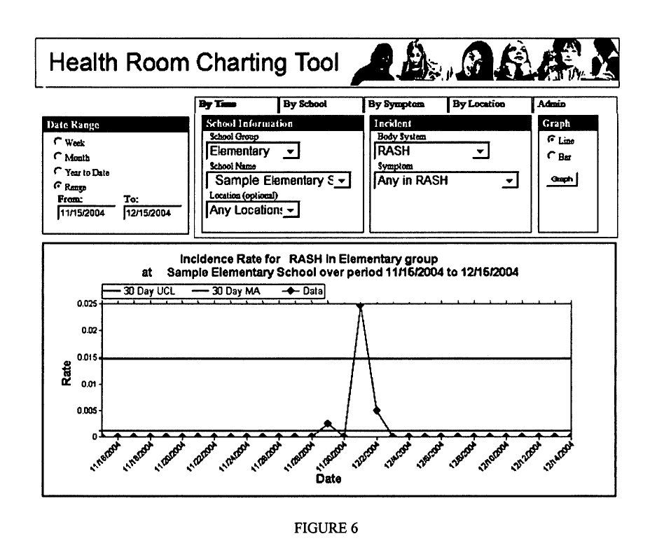

A second exemplary case further shows how the epidemiological and environmental monitoring and assessment system and method was applied in the school district. At the end of November, 2004, staff at one elementary school expressed concern that the incidence rate of rashes in their school may have been aberrant. The epidemiological and environmental monitoring and assessment system confirmed that the incidence rate was significantly greater than the historical average. This can be seen in FIG. 6, which shows, according to an exemplary embodiment, a sample Report 3: Incident Rates for Body System=Rash (comprising seven individual rash symptoms according to the schema presented in Table 2), School=Sample (comprising 1 elementary school out of 8 comprising the group elementary schools, in a school district with a total of 15 schools), Date Range=Nov. 15, 2004-Dec. 15, 2004. X axis=User selected range of dates. Y axis=Incidence Rate. From FIG. 6 it can be seen that the incidence rate for the body system rash exceeds the upper control limit (defined as 3 times the standard deviation of measurements made during the last 30 day period) during the selected time period. This constituted an aberrant increase.

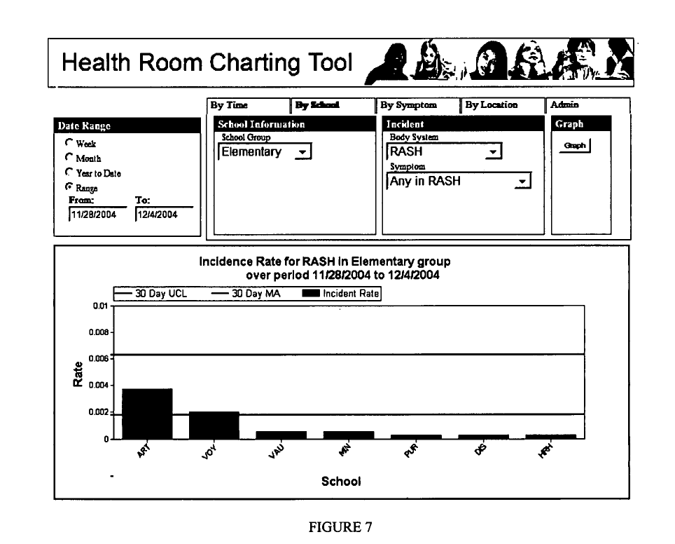

To develop further information to properly allocate resources, the data analysis features of the epidemiological and environmental monitoring and assessment system were selected to display a comparison of schools within the group Elementary Schools. This was done to determine if the increase in the incidence rate of the body system Rash observed in FIG. 6 was confined to one school, or was part of a non-localized general trend. FIG. 7 shows the results, according to an exemplary embodiment, in a sample Report 9: Incident Rates for Body System=Rash (comprising seven individual rash symptoms according to the schema presented in Table 2), School Group=Elementary (comprising 8 schools out of a school district of 15 schools), Date Range=Nov. 28, 2005-Dec. 4, 2005. X axis=Incidence Rates for individual schools in School Group Elementary. Y axis=Incidence Rate. As shown in FIG. 7, the epidemiological and environmental monitoring and assessment system revealed that the incident rate at the elementary school with the identifying code “ART”, representing the Sample Elementary School, was above what the others in the district were reporting. However, another school with the identifying code “VOY” also had an elevated incidence rate. School District medical professionals evaluated the situation, and concluded that the rashes were consistent with short-term outbreaks of unknown etiology as have been investigated by the Centers for Disease Control. It was concluded that the increase was a generalized trend and that no resources should be allocated for remediative measures. The staff of the elementary school were presented with the findings and were reassured to find that their school was not the only one experiencing these symptoms.

### EXAMPLE II

(The present invention can be implemented in nursing homes and the like)

According to additional aspects, in addition to schools, another example meeting the criteria are nursing homes. A group of nursing homes owned, for example, by one corporation, or within a given geographic area, meets the criteria of being a population distributed among two or more locations.

At each nursing home, medical staff constantly monitor the residents and generate continuous sources of diagnostic data regarding adverse health effects experienced by members of the population.

The medical records include at a minimum as environmental factor data the nursing home where the resident resides, and preferably additional environmental data.

### EXAMPLE III

(In particular embodiments, additional environmental parameters are monitored to allow for proactive and/or reactive steps)

According to additional aspects, additional environmental parameters (e.g., airborne carbon dioxide (CO₂)) are monitored and correlated with measurements of incidence rates of symptoms of building occupants, especially respiratory and neurological symptoms. A variety of continuous sensors are available to inexpensively and reliably measure CO₂ (e.g., sensors based on non-dispersive infrared spectrometry). It is widely recognized that ventilation rates can be inferred from CO₂ measurements. Building occupants generate CO₂ as a byproduct of respiration, thereby causing indoor carbon dioxide concentrations to exceed outdoor concentrations. The ventilation rate (understood to be the action of supplying outdoor air and removing indoor air from inside a building) can be estimated if the indoor carbon dioxide source strength and the concentrations of CO₂ in the supply air and room air are known. Specific techniques and methodology have been issued by ASTM International, a highly respected voluntary standards development organization, in “ASTM Standard D6245-98, Guide for Using Indoor Carbon Dioxide Concentrations to Evaluate Indoor Air Quality and Ventilation.”

This is the basis for the “ASHRAE Standard 62 Ventilation for Acceptable Indoor Air Quality” developed by the American Society of Heating, Refrigerating, and Air Conditioning Engineers. In the ASHRAE standard the relationship between outdoor air provided to occupants and the carbon dioxide levels is given by Equation 1:
V_{O}=N/(C_{S}−C_{O}) (1)
where:

V_{O}=outdoor airflow rate per person;

N=CO₂ generation rate per person;

C_{S}=indoor CO₂ concentration; and

C_{O}=outdoor CO₂ concentration.

Equation 1 can be rearranged to produce Equation 2, as follows:
(C_{S}−C_{O})=N/V_{O} (2)
Thus, if N remains constant by measuring C_{S} and C_{O}, the amount of outdoor air supplied to each person can be calculated. As an example, the ASHRAE standard specified rates at which outdoor air must be supplied to each room within a building range from 15 to 60 CFM/person (cubic feet per minute, per person), depending on the activities that normally occur in that room. Selecting V_{O} equal to 15 CFM, and with a typical occupant CO₂ generation rate of 0.3 L/min (0.01059 CFM), from Equation 2 it can be seen that in order to achieve an outdoor airflow rate of greater than 15 CFM/person, the indoor CO₂ must be less than approximately 700 ppm greater than the outside air (assuming outside levels are approximately 300 ppm) when an equilibrium condition has been reached.

Thus, when the environmental parameter carbon dioxide (CO₂) is monitored it can indicate how much outdoor air is being supplied to building occupants. The ASHRAE 62 Standard of 15 CFM/person itself is not a health based standard, but is instead based on studies showing minimum ventilation rates necessary to dilute offensive body odors. Nevertheless, if other contaminants are present their levels will increase or decrease in inverse proportion to the amount of outdoor air supplied to each occupant. Therefore, by measuring carbon dioxide one can evaluate whether ventilation rates are higher or lower than accepted standards, and as a consequence predict whether the levels of other environmental contaminants (if present) are lower or higher, respectively, than they might be in a building where the ASHRAE ventilation standard is exactly met.

Information about ventilation rates can be correlated with symptoms reported by building occupants. For example:

1. Volatile organic compounds are released by sources such as commonly-used cleaners, personal care products, adhesives, paints, pesticides solvents, wood preservatives, furnishings, and copying machines. Higher levels due to lower ventilation rates could cause neurological symptoms such as headaches, drowsiness and an inability to concentrate.

2. Dust can be released by humans, animals, the environment, draperies, carpet, and occupant activities. Higher levels due to lower ventilation rates could cause respiratory symptoms such as rhinitis.

3. Allergens such as molds and dust mites can grow indoors, while others such as animal dander and bacteria can be released by animals and humans. Higher levels due to lower ventilation rates could cause respiratory symptoms such as rhinitis, difficulty breathing and coughing.

Thus, by measuring the environmental parameter carbon dioxide (CO₂) information about the rate at which contaminants are flushed from the building environment can be obtained. When the rate of flushing falls below accepted ventilation guidelines, monitoring of symptoms reported by occupants can show whether or not they are being exposed to elevated levels of an indoor contaminant. The nature of the symptoms being reported can provide clues as to the nature of the indoor contaminant. Proactive or reactive steps can be taken to increase the ventilation rate and/or remove or otherwise control the indoor contaminant.

### EXAMPLE IV

(In particular embodiments, additional environmental parameters are monitored to allow for proactive and/or reactive steps)

According to additional aspects, additional environmental parameterers (e.g., airborne carbon monoxide (CO)) are monitored and correlated with measurements of incidence rates of symptoms of building occupants, especially gastrointestinal and neurological symptoms.

A growing body of literature suggests that there are adverse health effects associated with chronic exposure to carbon monoxide. Reported symptoms include headaches, drowsiness, nausea, dizziness and vomiting. Chronic CO poisoning is difficult to diagnose by those not skilled in its presentation. It is often mistaken for chronic fatigue syndrome, viral or bacterial pulmonary or gastrointestinal infection, excessive heat, etc. Traditional measurements of blood-bound CO (COHb) used to assess acute exposures to CO are not successful because COHb is usually not excessively elevated. More often than not, by the time air CO or blood CO levels are measured, the presence of CO in the environment has been corrected, making measurement impossible.

Several types of inexpensive and reliable CO monitors are available. They are based on various technologies including chem-optical (gel cell) or biomimetic alarms, electro-chemical sensors, and tin dioxide (semi-conductor) designs. Measurements of the environmental parameter carbon monoxide (CO) can be correlated with the incidence rate of gastrointestinal and neurological symptoms reported by building occupants. Proactive or reactive steps can be taken to increase the ventilation rate and/or remove or otherwise control carbon monoxide sources if it appears that building occupant health is being adversely impacted.

1. A method for epidemiological and environmental monitoring and assessment, comprising:
a) configuring, in one or a plurality of electronic databases stored in a storage device of a computer, a set of health-related occurrence data including respective occurrence dates, and a respective set of building environment data comprising at least respective occurrence location data, wherein the data sets correspond to a plurality of individuals occupying a building environment, and are continuously collected therefrom;
b) applying an epidemiological monitoring query procedure comprising use of an application interface to query the data base at least with respect to location and occurrence timing of the health-related data; and
c) presenting or outputting of the query results to provide a report, affording, at least in part, epidemiological and environmental monitoring and assessment.

2. The method of claim 1, wherein the health-related occurrence data is categorized according to a method selected from the group consisting of body systems and body system codes, symptoms and symptom codes, treatments and treatment codes, art-recognized medical criteria and codes, disposition and disposition codes, and combinations thereof.

3. The method of claim 1, wherein applying an epidemiological monitoring query procedure comprises use of at least one method selected from the group consisting of comparison, statistical process control, and advanced correlation analysis.

4. The method of claim 3, wherein trends or excursions are identified.

5. The method of claim 1, wherein the building environment data further comprises at least one data measurement selected from the monitoring group consisting of temperature, relative humidity, CO₂ concentration, CO concentration, particulate matter, allergens, fumes, toxins, airborne microbes, molds, chemicals, microbes, data that directly measures environmental conditions, data measuring factors that may indirectly affect environmental conditions, and data that directly measures environmental risks.

6. The method of claim 1, wherein the epidemiological and environmental monitoring and assessment is proactive.

7. The method of claim 1, wherein the occurrence location data comprises data selected from the group consisting of building environment designation, building designation, room or environ designation, and combinations thereof.

8. The method of claim 1, wherein the individuals occupying the building environment represent a homogeneous or substantially homogenous population of similarly situated individuals.

9. The method of claim 1, wherein the individuals occupying the building environment are spread among several locations, allowing for inter-location evaluation, intra-location evaluation, or both.

10. The method of claim 1, wherein the environmental data has a common associated time and location for each data point.

11. The method of claim 1, wherein the frequency of health-related data collection is short compared to onset of occurrence-related symptoms.

12. The method of claim 1, comprising determining incidence rates of respective symptoms and establishing a proactive or remedial baseline or threshold value for respective symptom incidence rates.

13. The method of claim 12, further comprising proactive intervention.

14. The method of claim 12, further comprising remedial intervention.

15. A system or computer apparatus for epidemiological and environmental monitoring and assessment, comprising:
a) a computer having a processor and at least one storage device connected thereto;
b) a database of health related data, comprising a stored set of a set of health-related occurrence data including respective occurrence dates, and wherein the data set corresponds to a plurality of individuals occupying a building environment, and is continuously collected therefrom;
c) a database of building environment data, comprising a stored set of respective building environment data and comprising at least respective occurrence location data, and wherein the data set corresponds to that of a building environment, and is continuously collected therefrom; and
d) a stored software program operative with the processor to receive and process a user's application of an epidemiological monitoring query procedure comprising use of an application interface to query the data base at least with respect to location and occurrence timing of the health-related data.

16. The system or computer apparatus of claim 15, wherein the health-related occurrence data is categorized according to a method selected from the group consisting of body systems and body system codes, symptoms and symptom codes, treatments and treatment codes, art-recognized medical criteria and codes, disposition s and disposition codes, and combinations thereof.

17. The system or computer apparatus of claim 15, wherein applying an epidemiological monitoring query procedure comprising use of at least one method selected from the group consisting of comparison, statistical Process control, and advanced correlation analysis.

18. The system or computer apparatus of claim 17, wherein trends or excursions are identified.

19. The system or computer apparatus of claim 15, wherein the building environment data further comprises at least one data measurement selected from the monitoring group consisting of temperature, relative humidity, CO₂ concentration, CO concentration, particulate matter, allergens, fumes, toxins, airborne microbes, molds, chemicals, microbes, data that directly measures environmental conditions, data measuring factors that may indirectly affect environmental conditions, and data that directly measures environmental risks.

20. The system or computer apparatus of claim 15, wherein the epidemiological and environmental monitoring and assessment is proactive.

21. The system or computer apparatus of claim 15, wherein the occurrence location data comprises data selected from the group consisting of building environment designation, building designation, room or environ designation, and combinations thereof.

22. The system or computer apparatus of claim 15, wherein the individuals occupying the building environment represent a homogeneous or substantially homogenous population of similarly situated individuals.

23. The system or computer apparatus of claim 15, wherein the individuals occupying the building environment are spread among several locations, allowing for inter-location evaluation, intra-location evaluation, or both.

24. The system or computer apparatus of claim 15, wherein the environmental data has a common associated time and location for each data point.

25. The system or computer apparatus of claim 15, wherein the frequency of health-related data collection is short compared to onset of occurrence-related symptoms.

26. The system or computer apparatus of claim 15, comprising determining incidence rates of respective symptoms and establishment of a proactive or remedial baseline or threshold value for respective symptom incidence rates.

27. The system or computer apparatus of claim 26, further comprising proactive intervention.

28. The system or computer apparatus of claim 26, further comprising remedial intervention.
